(19) United States
(12) Patent Application Publication
(10) Pub. No.: US 2025/0128811 A1
(43) Pub. Date: Apr. 24, 2025

(54) INFORMATION PROCESSING METHOD, INFORMATION PROCESSING PROGRAM, AND INFORMATION PROCESSING DEVICE

(71) Applicant: Sony Group Corporation, Tokyo (JP)

(72) Inventors: Keisuke MAEDA, Tokyo (JP); Seiji SUZUKI, Tokyo (JP)

(73) Assignee: Sony Group Corporation, Tokyo (JP)

(21) Appl. No.: 18/684,844

(22) PCT Filed: Mar. 11, 2022
(86) PCT No.: PCT/JP2022/010928

§ 371 Date: Feb. 20, 2024

(30) Foreign Application Priority Data
Sep. 2, 2021 (JP) 2021-143084

(51) Int. Cl. B64C 39/02; G06T 17/05; H04N 13/279; H04N 13/383

(52) U.S. Cl. CPC B64C 39/024; G06T 17/05; H04N 13/279; H04N 13/383

(57) ABSTRACT

An information processing method is an information processing method executed by one processor or executed by a plurality of processors in cooperation, the information processing method including a first acquisition step for acquiring map information, a second acquisition step for acquiring current position information of a flight vehicle, a third acquisition step for acquiring information concerning a virtual viewpoint for a user to check the flight vehicle in an image, and a generation step for generating a virtual viewpoint image, which is an image viewed from the virtual viewpoint, based on the map information, the current position information of the flight vehicle, and the information concerning the virtual viewpoint.

### FIELD

The present disclosure relates to an information processing method, an information processing program, and an information processing device.

### BACKGROUND

A technique for remotely operating a flight vehicle has been known. For example, a technique for enabling a user to remotely operate a drone from the ground while viewing an FPV (First Person View) image from a camera mounted on the drone has been known.

### CITATION LIST

### Patent Literature

Patent Literature 1: JP H09-91600 A

### SUMMARY

### Technical Problem

However, it is difficult for the user to accurately grasp positional relation between the flight vehicle and the peripheral environment only with the FPV image. Therefore, in the related art, an operator cannot accurately remotely operate the flight vehicle.

Therefore, the present disclosure proposes an information processing method, an information processing device, and an information processing program that enable accurate remote control of a flight vehicle.

Note that the problem or the object described above are merely one of a plurality of problems or objects that can be solved or achieved by a plurality of embodiments disclosed in the present specification.

### Solution to Problem

In order to solve the above problem, an information processing method according to one embodiment of the present disclosure executed by one processor or executed by a plurality of processors in cooperation, the information processing method includes: a first acquisition step for acquiring map information; a second acquisition step for acquiring current position information of a flight vehicle; a third acquisition step for acquiring information concerning a virtual viewpoint for a user to check the flight vehicle in an image; and a generation step for generating a virtual viewpoint image, which is an image viewed from the virtual viewpoint, based on the map information, the current position information of the flight vehicle, and the information concerning the virtual viewpoint.

### BRIEF DESCRIPTION OF DRAWINGS

FIG. 1 is a diagram illustrating an example of a virtual viewpoint image.

FIG. 2 is a diagram illustrating the virtual viewpoint image on which flight altitude display is superimposed.

FIG. 3 is a diagram illustrating a configuration example of a flight vehicle control system according to an embodiment of the present disclosure.

FIG. 4 is a diagram illustrating a configuration example of a server according to the embodiment of the present disclosure.

FIG. 5 is a diagram illustrating an example of a terminal device.

FIG. 6 is a diagram illustrating an example of a terminal device.

FIG. 7 is a diagram illustrating a configuration example of a terminal device according to the embodiment of the present disclosure.

FIG. 8 is a diagram illustrating a configuration example of a flight vehicle according to the embodiment of the present disclosure.

FIG. 9 is a diagram illustrating a functional configuration of the flight vehicle control system.

FIG. 10 is a diagram illustrating an example of an operation screen of the flight vehicle.

FIG. 11 is a diagram illustrating a trajectory input to the virtual viewpoint image by a user.

FIG. 12 is a diagram for explaining trajectory planning.

FIG. 13 is a flowchart illustrating map information acquisition processing.

FIG. 14 is a flowchart illustrating map generation processing.

FIG. 15 is a flowchart illustrating virtual viewpoint control processing.

FIG. 16 is a diagram for explaining position information of a virtual viewpoint.

FIG. 17 is a flowchart illustrating virtual viewpoint image generation processing.

### DESCRIPTION OF EMBODIMENTS

An embodiment of the present disclosure is explained in detail below with reference to the drawings. Note that, in the embodiment explained below, redundant explanation is omitted by denoting the same parts with the same reference numerals and signs.

In the present specification and the drawings, a plurality of components having substantially the same functional configuration may be distinguished by adding different numbers after the same reference signs. For example, a plurality of components having substantially the same functional configuration are distinguished as terminal devices 201 and 20: according to necessity. However, when it is not particularly necessary to distinguish each of the plurality of components having substantially the same functional configuration, only the same reference numeral or sign is added. For example, when it is not particularly necessary to distinguish the terminal devices 201 and 202, the terminal devices 201 and 20: are simply referred to as terminal devices 20.

One or a plurality of embodiments (including examples and modifications) explained below can be respectively independently implemented. On the other hand, at least a part of the plurality of embodiments explained below may be implemented in combination with at least a part of other embodiments as appropriate. These plurality of embodiments can include new characteristics different from one another. Therefore, these plurality of embodiments can contribute to solving objects or problems different from one another and can achieve effects different from one another.

The present disclosure is explained according to the following item order.
1. Overview
2. Configuration of flight vehicle control system
2-1. Configuration of server
2-2. Configuration of terminal device
2-3. Configuration of flight vehicle
2-4. Functional configuration of flight vehicle control system
3. Operation of flight vehicle control system
3-1. Overview of processing
3-2. Operation screen
3-3. Trajectory planning
4. Processing example
4-1. Map information acquisition processing
4-2. Virtual viewpoint control processing
4-3. Virtual viewpoint image generation processing
5. Modifications
6. Conclusion

### 1. Overview

A technique for remotely operating a flight vehicle has been known. For example, a technique for enabling a user to remotely operate a drone from the ground while viewing an FPV (First Person View) image from a camera mounted on the drone has been known. However, it is difficult for the user to accurately grasp positional relation between the flight vehicle and the peripheral environment only with the FPV image. Therefore, in the related art, an operator cannot accurately remotely operate the flight vehicle.

Therefore, in the present embodiment, for example, 3D image information (3D map data) such as Google Earth (registered trademark) is used. More specifically, an information processing device (for example, an operation terminal of a flight vehicle or a server connected to the operation terminal) sets, based on operation of the user, a virtual viewpoint on a 3D space corresponding to a real space in which the flight vehicle is currently flying. The position of the virtual viewpoint and the line-of-sight direction from the virtual viewpoint can be changed by the operation of the user. The information processing device generates an image (hereinafter referred to as virtual viewpoint image) viewed from the virtual viewpoint using 3D map information stored in advance in a storage unit. The virtual viewpoint image is, for example, a 3D image around the flight vehicle viewed from a virtual viewpoint.

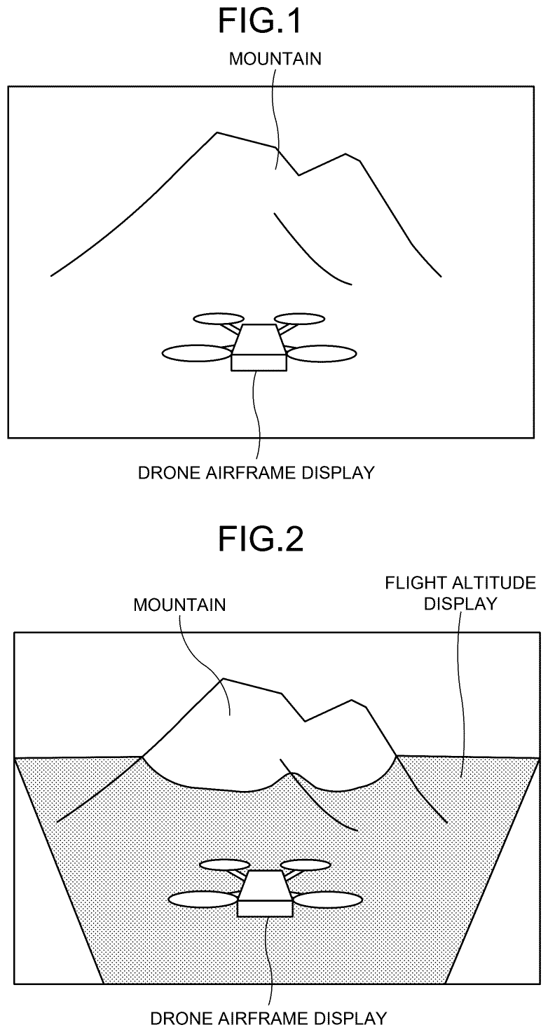

FIG. 1 is a diagram illustrating an example of a virtual viewpoint image. In the present embodiment, the virtual viewpoint image is assumed to be a real-time video. In the example illustrated in FIG. 1, a virtual viewpoint is set behind a drone. The information processing device uses 3D map information to display, on an operation terminal, a 3D map around the drone viewed from the virtual viewpoint set behind the drone.

Consequently, the user can accurately operate a flight vehicle not based on an image viewed from the flight vehicle but based on, for example, an image like a game in which the user follows the flight vehicle from behind the flight vehicle. Therefore, the user can accurately operate the flight vehicle. Since the user can move the position of the virtual viewpoint and the line-of-sight direction from the virtual viewpoint, it is easy to grasp a positional relation between the flight vehicle and the periphery of the flight vehicle.

Note that the information processing device may superimpose and display, in a place where the flight vehicle is located in the virtual viewpoint image, a virtual flight vehicle (for example, a virtual drone aircraft) generated from 3D model data of the flight vehicle. Consequently, since the user can overlook the periphery of the flight vehicle together with the flight vehicle, the user can more easily grasp the positional relationship between the flight vehicle and the periphery of the flight vehicle.

Depending on a flight area, in some case, the server does not have 3D map information of the area or, even if the server has 3D map information, the 3D map information is not high-definition 3D map information. In this case, the information processing device may generate high-definition 3D map information of the flight area based on information from a sensor (for example, a sensor that performs object detection and ranging such as LiDAR (light detection and ranging)) mounted on the flight vehicle. At this time, when a planned flight area is known beforehand, the information processing device may generate accurate 3D map information based on sensor information acquired by pre-flight of the flight vehicle. Consequently, when the user operates the flight vehicle, the information processing device can display a virtual viewpoint image with significant resolution on an operation terminal of the user.

It is important that the user prevent the flight vehicle from colliding with an obstacle when operating the flight vehicle. However, it is difficult to see whether the flight vehicle does not collide with an obstacle (whether a relevant area is a flyable area) if the user operates the flight vehicle while viewing a screen. Therefore, the information processing device may superimpose and display display (for example, flight altitude display) indicating the flyable area on the virtual viewpoint image. FIG. 2 is a diagram illustrating the virtual viewpoint image on which the flight altitude display is superimposed. The flight altitude display is display indicating an area where the flight vehicle can fly within predetermined altitude. In an example illustrated in FIG. 2, as the flight altitude display, a semitransparent plane is superimposed and displayed on altitude at which the flight vehicle is located. In the example illustrated in FIG. 2, the flight altitude display is performed at the altitude at which the flight vehicle is located. However, this display may be performed at the altitude designated by the user. This display may be performed not in the flyable area but in an area where there is a risk that the flight vehicle collides with an obstacle (for example, a building or a mountain). Since the flyable area is clearly seen, it is easy to operate the flight vehicle.

The overview of the present embodiment is explained above. A flight vehicle control system 1 according to the present embodiment is explained in detail below. Note that the flight vehicle control system can be referred to as information processing system instead.

### 2. Configuration of Flight Vehicle Control System

First, an overall configuration of the flight vehicle control system 1 is explained.

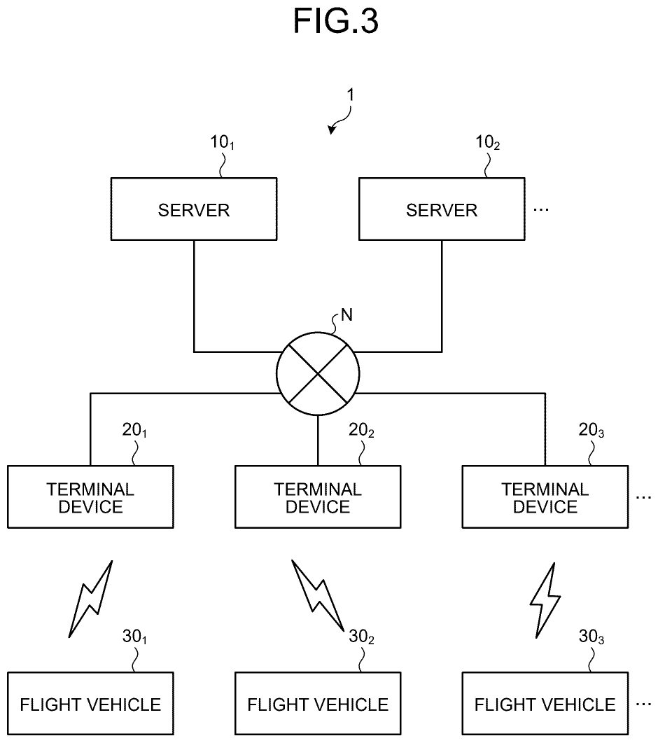

FIG. 3 is a diagram illustrating a configuration example of the flight vehicle control system 1 according to the embodiment of the present disclosure. The flight vehicle control system 1 is an information processing system that performs processing concerning flight of a flight vehicle 30. The flight vehicle control system 1 includes a server 10, a terminal device 20, and a flight vehicle 30. Note that the devices in the figure may be considered devices in a logical sense. That is, a part of the devices in the figure may be implemented by a virtual machine (VM), a container, a docker, and the like and may be implemented on physically the same hardware.

The server 10 and the terminal device 20 respectively have communication functions and are connected via a network N. The flight vehicle 30 has a wireless communication function and is connected to the terminal device 20 via radio. The flight vehicle 30 may be configured to be connectable to the network N. The server 10, the terminal device 20, and the flight vehicle 30 can be referred to as communication devices instead. Note that, although only one network N is illustrated in the example illustrated in FIG. 3, a plurality of networks N may be present.

Here, the network N is a communication network such as a LAN (Local Area Network), a WAN (Wide Area Network), a cellular network, a fixed telephone network, a regional IP (Internet Protocol) network, or the Internet. The network N may include a wired network or may include a wireless network. The network N may include a core network. The core network is, for example, an EPC (Evolved Packet Core) or a 5GC (5G Core network). The network N may include a data network other than the core network. The data network may be a service network of a telecommunications carrier, for example, an IMS (IP Multimedia Subsystem) network. The data network may be a private network such as an intra-company network.

The communication devices such as the terminal device 20 and the flight vehicle 30 may be configured to be connected to the network N or other communication devices using a radio access technology (RAT) such as LTE (Long Term Evolution), NR (New Radio), Wi-Fi, or Bluetooth (registered trademark). At this time, the communication devices may be configured to be capable of using different radio access technologies. For example, the communication devices may be configured to be capable of using the NR and the Wi-Fi. The communication devices may be configured to be capable of using different cellular communication technologies (for example, the LTE and the NR). The LTE and the NR are types of the cellular communication technology and enable mobile communication of the communication devices by disposing, in a cell shape, a plurality of areas covered by a base station.

Note that the communication devices such as the server 10, the terminal device 20, and the flight vehicle 30 may be connectable to the network N or other communication devices using a radio access technology other than the LTE, the NR, the Wi-Fi, and the Bluetooth. For example, the communication devices may be connectable to the network N or other communication devices using LPWA (Low Power Wide Area) communication. The communication devices may be connectable to the network N or other communication devices using wireless communication of an original standard. Naturally, the communication devices may be connectable to the network N or other communication devices using wireless communication of another known standard.

In the following explanation, configurations of the devices configuring the flight vehicle control system 1 are specifically explained. Note that the configurations of the devices explained below are only an example. The configurations of the devices may be different from the configurations explained below.

### <2-1. Configuration of Server>

First, a configuration of the server 10 is explained.

The server 10 is an information processing device (a computer) that performs processing concerning flight control for the flight vehicle 30. For example, the server 10 is a computer that performs automatic flight processing for the flight vehicle 30 and processing for estimating a position and a posture of the flight vehicle 30. Computers of all forms can be adopted as the server 10. For example, the server 10 may be a PC server, may be a midrange server, or may be a mainframe server.

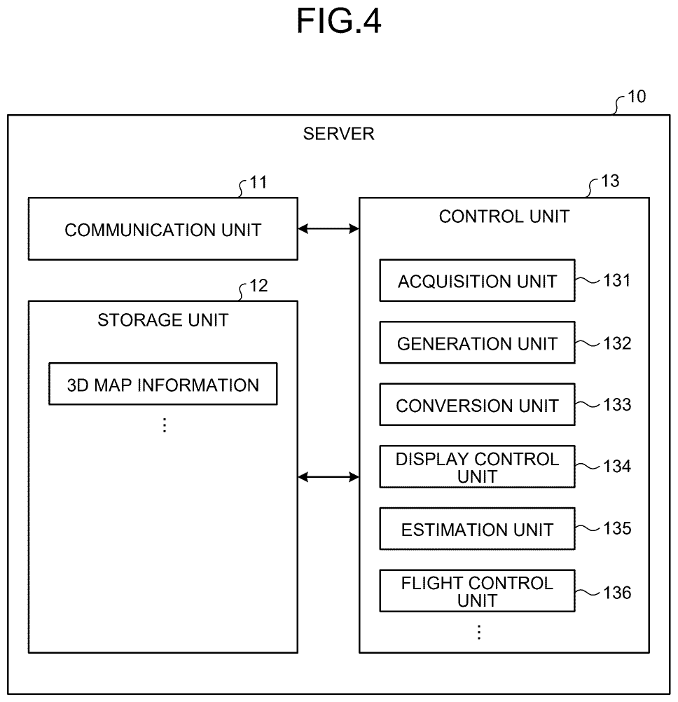

FIG. 4 is a diagram illustrating a configuration example of the server 10 according to the embodiment of the present disclosure. The server 10 includes a communication unit 11, a storage unit 12, and a control unit 13. Note that the configuration illustrated in FIG. 4 is a functional configuration. A hardware configuration may be different from this configuration. The functions of the server 10 may be implemented in a distributed to a plurality of physically separated components. For example, the server 10 may be configured by a plurality of server devices.

The communication unit 11 is a communication interface for communicating with other devices. For example, the communication unit 11 is a LAN (Local Area Network) interface such as an NIC (Network Interface Card). The communication unit 11 may be a wired interface or may be a wireless interface. The communication unit 11 communicates with the terminal device 20, the flight vehicle 30, and the like according to the control of the control unit 13.

The storage unit 12 is a data readable/writable storage device such as a DRAM (Dynamic Random Access Memory), an SRAM (Static Random Access Memory), a flash memory, or a hard disk. The storage unit 12 functions as storage means of the server 10. The storage unit 12 stores, for example, 3D map information.

The control unit 13 is a controller that controls the units of the server 10. The control unit 13 is implemented by a processor such as a CPU (Central Processing Unit), an MPU (Micro Processing Unit), or a GPU (Graphics Processing Unit). For example, the control unit 13 is implemented by the processor executing various programs stored in a storage device inside the server 10 using a RAM (Random Access Memory) or the like as a work area. Note that the control unit 13 may be implemented by an integrated circuit such as an ASIC (Application Specific Integrated Circuit) or an FPGA (Field Programmable Gate Array). All of the CPU, the MPU, the GPU, the ASIC, and the FPGA can be regarded as the controller.

The control unit 13 includes an acquisition unit 131, a generation unit 132, a conversion unit 133, a display control unit 134, an estimation unit 135, and a flight control unit 136. Blocks (the acquisition unit 131 to the flight control unit 136) configuring the control unit 13 are respectively functional blocks indicating functions of the control unit 13. These functional blocks may be software blocks or may be hardware blocks. For example, each of the functional blocks explained above may be one software module implemented by software (including a micro program) or may be one circuit block on a semiconductor chip (die). Naturally, each of the functional blocks may be one processor or one integrated circuit. The control unit 13 may be configured by functional units different from the functional blocks explained above. A configuration method for the functional blocks is optional.

Note that the control unit 13 may be configured by functional units different from the functional blocks explained above. Other devices may perform a part or all of the operations of the blocks (the acquisition unit 131 to the flight control unit 136) configuring the control unit 13. For example, one or a plurality of control units selected out of the control unit 23 of the terminal device 20 and the control unit 33 of the flight vehicle 30 may perform a part or all of the operations of the blocks configuring the control unit 13. Operations of the blocks configuring the control unit 13 are explained below.

### <2-2. Configuration of Terminal Device>

Next, a configuration of the terminal device 20 is explained.

The terminal device 20 is a communication device that communicates with the server 10 and the flight vehicle 30. For example, the terminal device 20 is a terminal carried by a user who manually operates the flight vehicle 30. The terminal device 20 transmits, for example, control information for the user to control the flight vehicle 30 to the flight vehicle 30. The terminal device 20 receives, for example, a current state of the flight vehicle 30 (for example, information concerning the position and the posture of the flight vehicle 30) from the flight vehicle 30. The terminal device 20 may be configured to exchange information for controlling the flight vehicle 30 (for example, information for automatic flight control for the flight vehicle 30 and estimation information of the position and the posture of the flight vehicle 30) with the server 10.

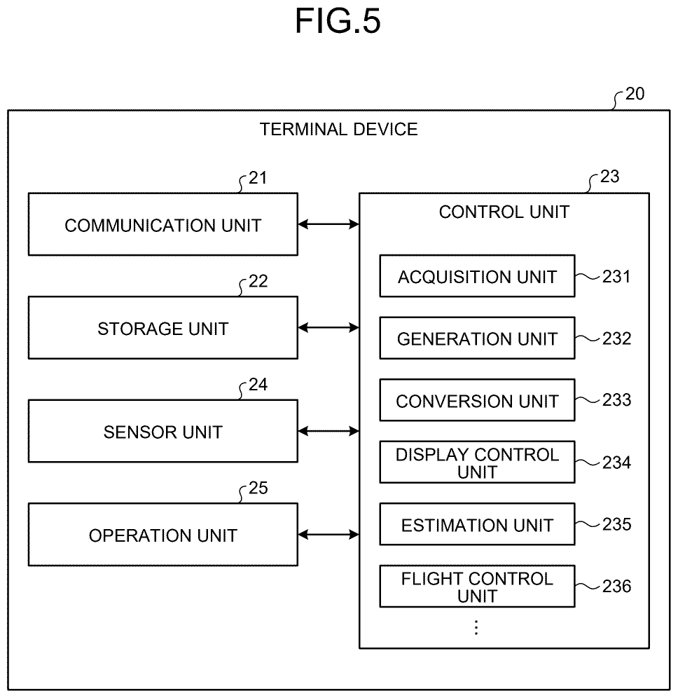

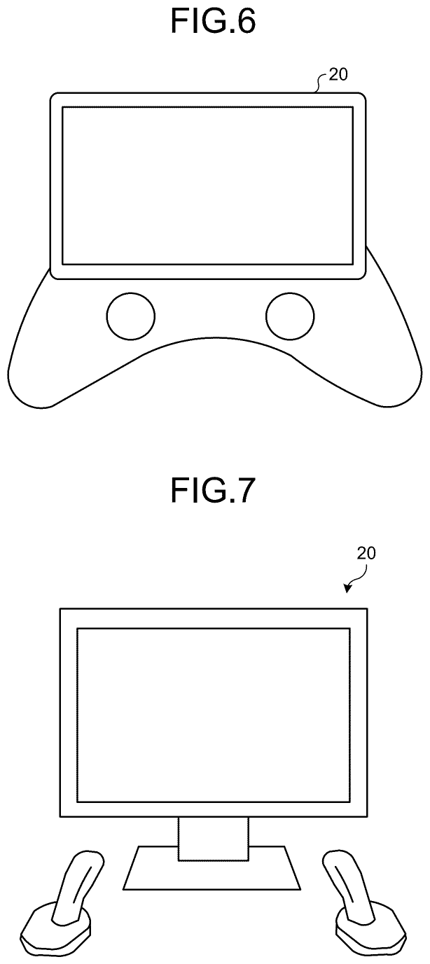

The terminal device 20 is, for example, a proportional system used by the user to operate the flight vehicle 30. The terminal device 20 is not limited to the proportional system and may be, for example, a cellular phone, a smart device (a smartphone or a tablet device), a PDA (Personal Digital Assistant), or a personal computer. FIG. 5 and FIG. 6 are respectively diagrams illustrating examples of the terminal device 20. The terminal device 20 is not limited to a smart device or a personal computer and may be, for example, a controller with a display illustrated in FIG. 5. The terminal device 20 may be, for example, a joystick with a display illustrated in FIG. 6.

The terminal device 20 may be an imaging device (for example, a camcorder) including a communication function or may be a mobile body (for example, a motorcycle or a mobile relay car) on which communication equipment such as an FPU (Field Pickup Unit) is mounted. The terminal device 20 may be an M2M (Machine to Machine) device or an IoT (Internet of Things) device. The terminal device 20 may be a router. Furthermore, the terminal device 20 may be an xR device such as an AR (Augmented Reality) device, a VR (Virtual Reality) device, or a MR (Mixed Reality) device. The terminal device 20 may be a wearable device such as a smart watch.

FIG. 7 is a diagram illustrating a configuration example of the terminal device 20 according to the embodiment of the present disclosure. The terminal device 20 includes a communication unit 21, a storage unit 22, a control unit 23, a sensor unit 24, and an operation unit 25. Note that the configuration illustrated in FIG. 7 is a functional configuration and a hardware configuration may be different from the functional configuration. The functions of the terminal device 20 may be implemented to be distributed in a plurality of physically separated components.

The communication unit 21 is a communication interface for communicating with other devices. For example, the communication unit 21 is a LAN interface such as an NIC. Note that the communication unit 21 may be a wired interface or may be a wireless interface. The communication unit 21 communicates with the server 10, the flight vehicle 30, and the like according to the control of the control unit 23.

The storage unit 22 is a data readable/writable storage device such as a DRAM, an SRAM, a flash memory, or a hard disk. The storage unit 22 functions as storage means of the terminal device 20. The storage unit 22 stores, for example, a feature point map.

The control unit 23 is a controller that controls the units of the terminal device 20. The control unit 23 is implemented by a processor such as a CPU, an MPU, or a GPU. For example, the control unit 23 is implemented by the processor executing various programs stored in a storage device inside the terminal device 20 using a RAM or the like as a work area. Note that the control unit 23 may be implemented by an integrated circuit such as an ASIC or an FPGA. All of the CPU, the MPU, the GPU, the ASIC, and the FPGA can be regarded as the controller.

The control unit 23 includes an acquisition unit 231, a generation unit 232, a conversion unit 233, a display control unit 234, an estimation unit 235, and a flight control unit 236. The blocks (the acquisition unit 231 to the flight control unit 236) configuring the control unit 23 are respectively functional blocks indicating functions of the control unit 23. These functional blocks may be software blocks or may be hardware blocks. For example, each of the functional blocks explained above may be one software module implemented by software (including a micro program) or may be one circuit block on a semiconductor chip (die). Naturally, each of the functional blocks may be one processor or one integrated circuit. The control unit 23 may be configured by functional units different from the functional blocks. A configuration method for the functional blocks is optional.

Note that the control unit 23 may be configured by functional units different from the functional blocks explained above. Another device may perform a part or all of the operations of the blocks (the acquisition unit 231 to the flight control unit 236) configuring the control unit 23. For example, one or a plurality of control units selected out of the control unit 13 of the server 10 and the control unit 33 of the flight vehicle 30 may perform a part or all of the operations of the blocks configuring the control unit 23.

The sensor unit 24 is a sensor that acquires information concerning the position or the posture of the terminal device 20. For example, the sensor unit 24 is a GNSS (Global Navigation Satellite System) sensor. Here, the GNSS sensor may be a GPS (Global Positioning System) sensor, may be a GLONASS sensor, may be a Galileo sensor, or may be a QZSS (Quasi-Zenith Satellite System) sensor. The GNSS sensor can be referred to as GNSS receiving module instead. Note that the sensor unit 24 is not limited to the GNSS sensor and may be, for example, an acceleration sensor. The sensor unit 24 may be a combination of a plurality of sensors.

The operation unit 25 is an operation device for the user to perform various kinds of operation. For example, the operation unit 25 includes a lever, buttons, a keyboard, a mouse, and operation keys. Note that, when a touch panel is adopted as the terminal device 20, the touch panel is also included in the operation unit 25. In this case, the user performs various kinds of operation by touching the screen with a finger or a stylus.

### <2-3. Configuration of Flight Vehicle>

Next, a configuration of the flight vehicle 30 is explained.

The flight vehicle 30 is a flight vehicle configured such that the user can manually operate the flight vehicle from a remote location using the terminal device 20. The flight vehicle 30 may be configured to automatically fly.

The flight vehicle 30 is typically a drone but may not necessarily be the drone. For example, the flight vehicle 30 may be a mobile body that moves in the atmosphere other than the drone. For example, the flight vehicle 30 may be an aircraft such as an airplane, an airship, or a helicopter. Here, the concept of the aircraft includes not only heavy aircrafts such as an airplane and a glider but also light aircrafts such as a balloon and an airship. The concept of the aircraft includes not only the heavy aircrafts and the light aircrafts but also rotary wing aircrafts such as a helicopter and an auto-gyroscope.

Note that the flight vehicle 30 may be a manned aircraft or an unmanned aircraft. Here, the concept of the unmanned aircraft also includes an unmanned aircraft system (UAS) and a tethered UAS. The concept of the unmanned aircraft includes a Lighter than Air UAS (LTA) and a Heavier than Air UAS (HTA). Besides, the concept of the unmanned aircraft also includes High Altitude UAS Platforms (HAPs). The drone is a type of the unmanned aircraft.

The flight vehicle 30 may be a mobile body that moves outside the atmosphere. For example, the flight vehicle 30 may be an artificial celestial body such as an artificial satellite, a spacecraft, a space station, or a probe.

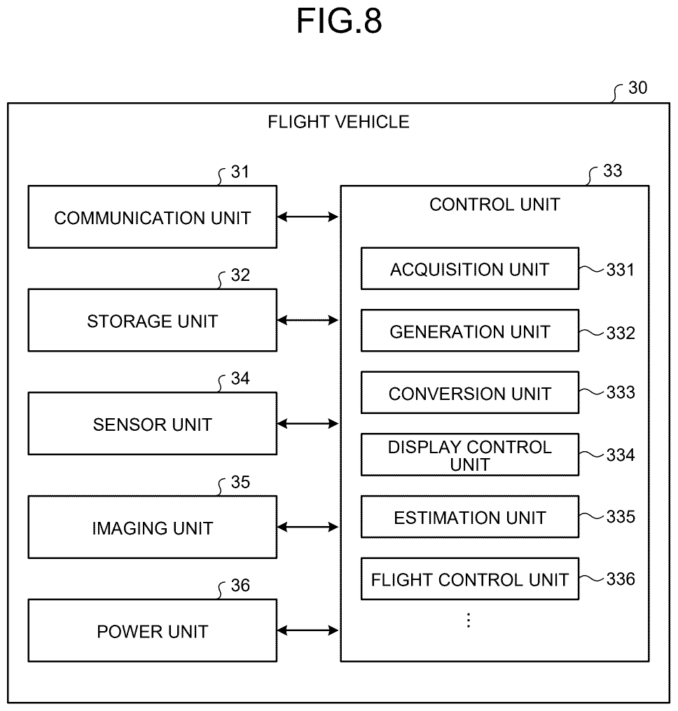

FIG. 8 is a diagram illustrating a configuration example of the flight vehicle 30 according to the embodiment of the present disclosure. The flight vehicle 30 includes a communication unit 31, a storage unit 32, a control unit 33, a sensor unit 34, an imaging unit 35, and a power unit 36. Note that the configuration illustrated in FIG. 8 is a functional configuration. A hardware configuration may be different from this configuration. The functions of the flight vehicle 30 may be implemented to be distributed to a plurality of physically separated components.

The communication unit 31 is a communication interface for communicating with other devices. For example, the communication unit 31 is a LAN interface such as an NIC. Note that the communication unit 31 may be a wired interface or may be a wireless interface. The communication unit 31 communicates with the server 10, the terminal device 20, the flight vehicle 30, and the like according to the control of the control unit 33.

The storage unit 32 is a storage device capable of reading and writing data such as a DRAM, an SRAM, a flash memory, or a hard disk. The storage unit 32 functions as storage means of the flight vehicle 30. The storage unit 32 stores, for example, a feature point map.

The control unit 33 is a controller that controls the units of the flight vehicle 30. The control unit 33 is implemented by a processor such as a CPU, an MPU, or a GPU. For example, the control unit 33 is implemented by the processor executing various programs stored in a storage device inside the flight vehicle 30 using a RAM or the like as a work area. Note that the control unit 33 may be implemented by an integrated circuit such as an ASIC or an FPGA. All of the CPU, the MPU, the GPU, the ASIC, and the FPGA can be regarded as the controller.

The control unit 33 includes an acquisition unit 331, a generation unit 332, a conversion unit 333, a display control unit 334, an estimation unit 335, and a flight control unit 336. The blocks (the acquisition unit 331 to the flight control unit 336) configuring the control unit 33 are functional blocks indicating functions of the control unit 33. These functional blocks may be software blocks or may be hardware blocks. For example, each of the functional blocks explained above may be one software module implemented by software (including a micro program) or may be one circuit block on a semiconductor chip (die). Naturally, each of the functional blocks may be one processor or one integrated circuit. The control unit 33 may be configured by functional units different from the functional blocks explained above. A configuration method for the functional blocks is optional.

Note that the control unit 33 may be configured by functional units different from the functional blocks explained above. Another device may perform a part or all of the operations of the blocks (the acquisition unit 331 to the flight control unit 336) configuring the control unit 33. For example, one or a plurality of control units selected out of the control unit 13 of the server 10 and the control unit 23 of the terminal device 20 may perform a part or all of the operations of the blocks configuring the control unit 33.

The imaging unit 35 is a conversion unit that converts an optical image into an electric signal. The imaging unit 35 includes, for example, an image sensor and a signal processing circuit that processes an analog pixel signal output from the image sensor. The imaging unit 35 converts light entering from a lens into digital data (image data). Note that an image captured by the imaging unit 35 is not limited to a video (a moving image) and may be a still image. Note that the imaging unit 35 may be a camera. At this time, the imaging unit 35 can be referred to as FPV (First Person View) camera.

The sensor unit 34 is a sensor that acquires information concerning the position or the posture of the flight vehicle 30. For example, the sensor unit 34 is a GNSS sensor. Here, the GNSS sensor may be a GPS sensor, may be a GLONASS sensor, may be a Galileo sensor, or may be a QZSS sensor. The GNSS sensor can be referred to as GNSS receiving module instead. Note that the sensor unit 34 is not limited to the GNSS sensor and may be, for example, an acceleration sensor. Besides, the sensor unit 34 may be an IMU (Inertial Measurement Unit), may be a barometer, may be a geomagnetic sensor, or may be an altimeter. The sensor unit 34 may be a combination of a plurality of sensors.

The sensor unit 34 may be a sensor for generating 3D map information. More specifically, the sensor unit 34 may be a sensor that reads three-dimensional structure of the peripheral environment. For example, the sensor unit 34 may be a depth sensor such as LiDAR (light detection and ranging). Naturally, the sensor unit 24 may be a depth sensor other than the LiDAR. The sensor unit 34 may be a distance measuring system in which a millimeter wave radar is used. Besides, the sensor unit 34 may be a ToF (Time of Flight) sensor or may be a stereo camera.

The power unit 36 is power that enables flight vehicle 30 to fly. For example, the power unit 36 is a motor that drives various mechanisms included in the flight vehicle 30.

### <2-4. Functional Configuration of Flight Vehicle Control System>

The configurations of the devices configuring the flight vehicle control system 1 is explained above. The flight vehicle control system 1 can also be configured as follows. A functional configuration of the flight vehicle control system is explained below.

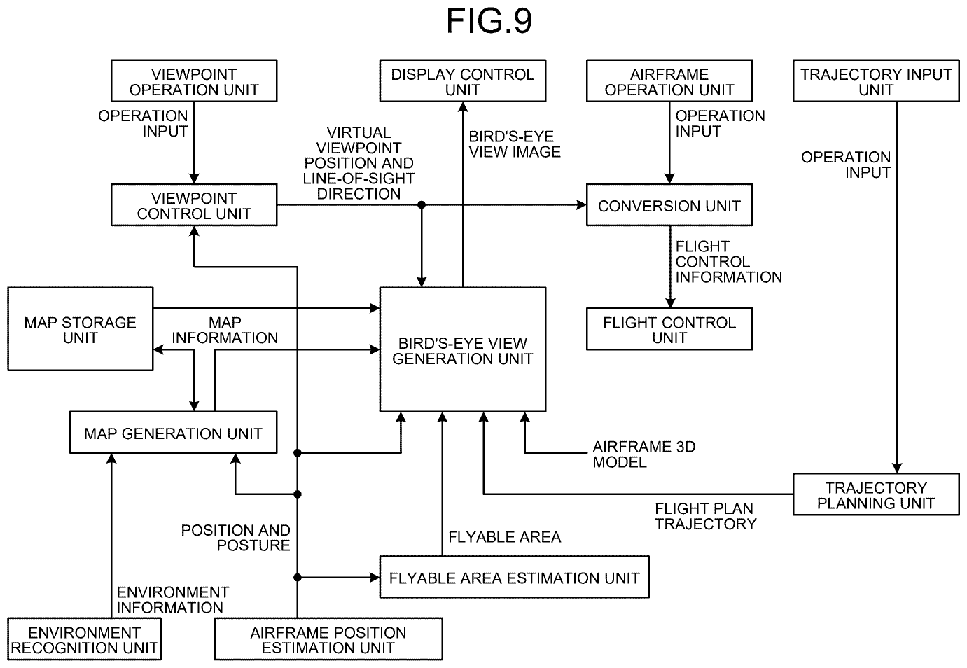

FIG. 9 is a diagram illustrating a functional configuration of the flight vehicle control system 1. The flight vehicle control system 1 includes a viewpoint operation unit, a display control unit, an airframe operation unit, a trajectory input unit, a viewpoint control unit, a conversion unit, a map storage unit, a map generation unit, a bird's-eye view generation unit, a flight control unit, an environment recognition unit, an airframe position estimation unit, a flyable area estimation unit, and a trajectory planning unit.

The viewpoint operation unit, the airframe operation unit, and the trajectory input unit are equivalent to the operation unit 25 of the terminal device 20. For example, the viewpoint operation unit receives operation input from the user concerning movement of a virtual viewpoint and outputs the operation input to the viewpoint control unit. For example, the airframe operation unit receives operation input from the user concerning operation of the flight vehicle and outputs the operation input to the conversion unit. For example, the trajectory input unit receives operation input from the user concerning a flight trajectory of the flight vehicle and outputs the operation input to the trajectory planning unit.

The map storage unit is equivalent to the storage unit 12 of the server 10, the storage unit 22 of the terminal device 20, or the storage unit 32 of the flight vehicle 30. The map storage unit stores 3D map information.

The airframe position estimation unit, the viewpoint control unit, the environment recognition unit, and the trajectory planning unit are equivalent to the acquisition unit 131 of the server 10, the acquisition unit 231 of the terminal device 20, or the acquisition unit 331 of the flight vehicle 30. For example, the airframe posture estimation unit estimates a position and a posture of the flight vehicle 30 based on information from the sensor unit 34 of the flight vehicle 30 and outputs the position and the posture to the map generation unit and the viewpoint control unit. For example, the viewpoint control unit specifies a position and a line-of-sight direction of a virtual viewpoint based on information from the viewpoint operation unit and the airframe position estimation unit and outputs the position and the line-of-sight direction to the conversion unit and the bird's-eye view generation unit. The environment recognition unit recognizes environment (for example, three-dimensional structure) around the flight vehicle based on, for example, information from the sensor unit 34 of the flight vehicle 30 and outputs a recognition result to the map generation unit. For example, the trajectory planning unit specifies a flight plan trajectory of the flight vehicle 30 based on operation input from the user and outputs the flight plan trajectory to the bird's-eye view generation unit.

The flyable area estimation unit is equivalent to the estimation unit 135 of the server 10, the estimation unit 235 of the terminal device 20, or the estimation unit 335 of the flight vehicle 30. The flyable area estimation unit estimates, for example, a flyable area at the current altitude of the flight vehicle 30.

The map generation unit and the bird's-eye view generation unit are equivalent to the generation unit 132 of the server 10, the generation unit 232 of the terminal device 20, or the generation unit 332 of the flight vehicle 30. The map generation unit generates, based on, for example, the environment recognition unit and the airframe position estimation unit, a 3D map of an area where the flight vehicle 30 flied and accumulates the 3D map in the map storage unit. The bird's-eye view generation unit generates a bird's-eye view (a virtual viewpoint image) viewed from the virtual viewpoint based on, for example, the map information, the virtual viewpoint information, information concerning the position and the posture of the flight vehicle 30, airframe 3D model information of the flight vehicle 30, information concerning the flyable area, information concerning flight plan trajectory, and the like.

The display control unit is equivalent to the display control unit 134 of the server 10, the display control unit 234 of the terminal device 20, or the display control unit 334 of the flight vehicle 30. The display control unit performs, for example, display control for a bird's eye view on the terminal device 20.

The conversion unit is equivalent to the conversion unit 133 of the server 10, the conversion unit 233 of the terminal device 20, or the conversion unit 333 of the flight vehicle 30. For example, the conversion unit converts input from the user concerning operation of the flight vehicle 30 into control information of the flight vehicle 30 and outputs the control information to the flight control unit.

The flight control unit is equivalent to the flight control unit 136 of the server 10, the flight control unit 236 of the terminal device 20, or the flight control unit 336 of the flight vehicle 30. For example, the flight control unit performs flight control for the flight vehicle 30 based on flight control information from the conversion unit.

### 3. Operation of Flight Vehicle Control System

The configuration of the flight vehicle control system 1 is explained above. Next, an operation of the flight vehicle control system 1 having such a configuration is explained.

### <3-1. Overview of Processing>

First, an overview of processing of the flight vehicle control system 1 is explained. The operation of the flight vehicle control system 1 explained below may be executed by any one of a plurality of devices (the server 10, the terminal device 20, and the flight vehicle 30) configuring the flight vehicle control system 1 or may be executed by control units (information processing devices) of the plurality of devices configuring the flight vehicle control system 1 in cooperation. In the following explanation, it is assumed that the information processing device executes the processing.

The processing of the flight vehicle control system 1 in the present embodiment is divided into following (1) to (5).
(1) Generation of a virtual viewpoint image
(2) Generation of 3D map information
(3) Display of a flyable area
(4) Conversion of operation input of the user into flight control information
(5) Flight control by trajectory planning

### (1) Generation of a Virtual Viewpoint Image

The information processing device acquires 3D map information from the storage unit. Alternatively, the information processing device acquires 3D map information from the storage unit of another device (for example, if the information processing device is the terminal device 20, from the server 10) via the network N. The information processing device acquires current position information of the flight vehicle 30. Further, the information processing device acquires information (Information concerning a position and a line-of-sight direction) of a virtual viewpoint. Here, the information concerning the virtual viewpoint is relative position information based on the position of the flight vehicle 30. The position of the virtual viewpoint and the line-of-sight direction from the virtual viewpoint can be changed by operation of the user.

The information processing device generates a 3D image (a virtual viewpoint image) viewed from the position of the virtual viewpoint in the set line-of-sight direction based on the current position information of the flight vehicle 30 and the information concerning the virtual viewpoint. At this time, if the virtual viewpoint is set behind the flight vehicle 30 and the line-of-sight direction is obliquely set, the virtual viewpoint image generated by the information processing device is, for example, an image obliquely looking down the flight vehicle 30 and the periphery of the flight vehicle 30 from behind the flight vehicle 30. If the virtual viewpoint is set behind the flight vehicle 30 and the line-of-sight direction is obliquely set, the virtual viewpoint image generated by the information processing device is, for example, an image obliquely looking down the flight vehicle 30 and the periphery of the flight vehicle 30 from behind the flight vehicle 30. If the virtual viewpoint is set above the flight vehicle 30 and the line-of-sight direction is set to a directly downward direction, the virtual viewpoint image generated by the information processing device is, for example, an image (planar image) looking down the flight vehicle 30 and the periphery of the flight vehicle 30 right below from above the flight vehicle 30. The information processing device displays the generated virtual viewpoint image on the screen of the terminal device 20.

Consequently, the user can operate the flight vehicle 30 based on an image from any viewpoint. Therefore, the user can accurately operate the flight vehicle. Moreover, since the user can move the position of the virtual viewpoint and the line-of-sight direction from the virtual viewpoint, it is easy to grasp a positional relation between the flight vehicle 30 and the periphery of the flight vehicle 30.

### (2) Generation of 3D Map Information

Depending on an area where the flight vehicle 30 flies, it could occur that 3D map information of the area is absent in the storage unit or, even if 3D map information is present, the 3D map information is not high-definition 3D map information. In this case, the information processing device may generate high-definition 3D map information of the flight area based on information from the sensor unit 34 (for example, LiDAR) mounted on the flight vehicle 30. At this time, when a planned flight area is known beforehand, the information processing device may generate accurate 3D map information based on sensor information acquired by pre-flight of the flight vehicle 30.

Consequently, the information processing device can display a virtual viewpoint image with significant resolution on the terminal device 20 when the user operates the flight vehicle.

### (3) Display of a Flyable Area

When the user operates the flight vehicle, it is important not to collide with an obstacle. However, it is difficult to see whether the flight vehicle does not collide with an obstacle (whether a relevant area is a flyable area) if the user operates the flight vehicle while viewing a screen. Therefore, the information processing device displays the flyable area on the terminal device 20 according to operation of the user. Specifically, the information processing device performs the following processing.

First, the information processing device estimates a flyable area of the flight vehicle 30. For example, 3D map information includes information concerning an object obstructing flight of the flight vehicle 30 (3D data of mountains and buildings). The information processing device estimates a flyable area of the flight vehicle 30 based on the 3D map information. The flyable area is, for example, a movable plane at the current altitude of the flight vehicle. The information processing device adds display concerning the estimated flyable area (display of the movable plane) to the virtual viewpoint image. For example, the information processing device superimposes and displays a translucent movable plane on the virtual viewpoint image. The information processing device displays, on the terminal device 20, the virtual viewpoint image to which the display of the flyable area is added.

Consequently, since the user can clearly see the flyable area, the user can easily operate the flight vehicle 30.

(4) Conversion of Operation Input of the User into Flight Control Information

The information processing device acquires operation input of the user relating to flight control for the flight vehicle 30. The information processing device converts the operation input of the user into control information for flight control of the flight vehicle 30. At this time, the information processing device changes a method of converting the operation input into the control information according to the position of the virtual viewpoint. For example, the information processing device changes a flight control amount with respect to an operation input amount of the user according to whether the virtual viewpoint is far from or close to the flight vehicle 30. Consequently, an operation feeling matching the user's feeling can be realized.

### (5) Flight Control by Trajectory Planning

The information processing device acquires input of the user concerning a flight trajectory of the flight vehicle 30. The information processing device adds display of a flight plan trajectory of the flight vehicle 30 specified based on the input of the user to the virtual viewpoint image. The information processing device displays, on the terminal device 20, the virtual viewpoint image to which the display of the flight plan trajectory is added. At this time, the information processing device controls the flight of the flight vehicle 30 based on information concerning the flight plan trajectory. Consequently, the user can easily cause the flight vehicle 30 to automatically fly.

### <3-2. Operation Screen>

The user operates the flight vehicle 30 using the terminal device 20. An example of an operation screen of the flight vehicle 30 is explained below.

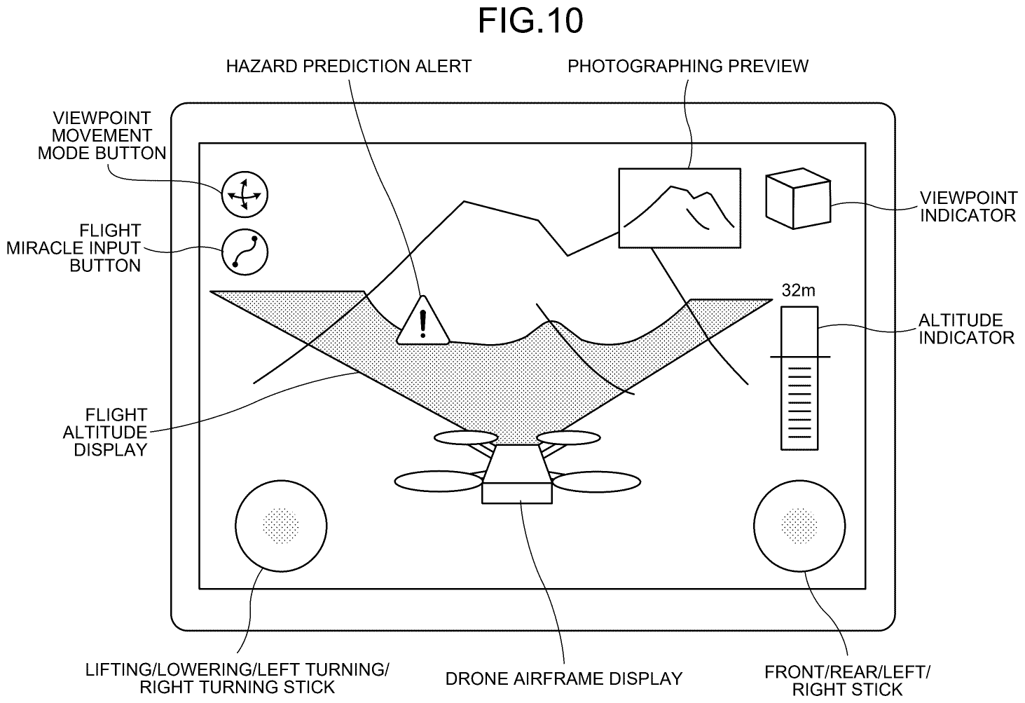

FIG. 10 is a diagram illustrating an example of an operation screen of the flight vehicle 30. In the example illustrated in FIG. 10, the terminal device 20 for operating the flight vehicle 30 is a tablet terminal. However, the terminal device 20 is not limited to the tablet terminal. On the screen of the terminal device 20, a virtual flight vehicle 30 (for example, the flight vehicle 30 reproduced by computer graphics (CG)) generated from the 3D model information of the flight vehicle 30 is displayed. In the example illustrated in FIG. 10, drone airframe display is the virtual flight vehicle 30. In the example illustrated in FIG. 10, the virtual viewpoint is located behind the flight vehicle 30. Therefore, a virtual viewpoint image from behind the flight vehicle 30 is displayed on the terminal device 20.

As explained above, the virtual viewpoint image is a 3D image (a 3D video) generated from 3D map information. In the following explanation, in order to facilitate understanding, a virtual camera positioned at a virtual viewpoint is assumed. It is assumed that the virtual viewpoint image is an image captured by the virtual camera. That is, in the following explanation, the position of the virtual camera is the position of the virtual viewpoint and a photographing direction of the virtual camera is the line-of-sight direction from the virtual viewpoint.

On the terminal device 20, as a GUI (Graphical User Interface), sticks for drone operation, a viewpoint indicator, a viewpoint movement mode button, and a flight trajectory input button are superimposed and displayed on a virtual viewpoint image. On the terminal device 20, flight altitude display, an altitude indicator, a hazard prediction alert, and a photographing preview are superimposed and displayed on the virtual viewpoint image.

The sticks for drone operation are GUIs for lifting/lowering/turning to the left/turning to the right the flight vehicle 30 or for moving the flight vehicle 30 forward/backward/to the left/to the right. In the example illustrated in FIG. 10, a lifting/lowering/left turning/right turning stick and a front/rear/left/right stick are displayed as the sticks for drone operation. The sticks for drone operation are equivalent to the airframe operation unit illustrated in FIG. 9.

The viewpoint indicator is a GUI that displays a line-of-sight direction from the virtual viewpoint. In the example illustrated in FIG. 10, the viewpoint indicator is displayed like a cube. In the example illustrated in FIG. 10, nothing is displayed on surfaces of the cube. However, up, down, left, right, front, and rear may be respectively displayed on the surfaces of the cube. When the user rotates the cube with operation such as swipe and taps any surface of the cube, the photographing direction of the virtual camera is switched. For example, when the user taps the surface of the cube on which “up” is described, the information processing device switches the photographing direction of the virtual camera to the upward direction. The viewpoint indicator is equivalent to the viewpoint operation unit.

The viewpoint movement mode button is a button for entering a mode for changing the position of the virtual viewpoint and the line-of-sight direction from the virtual viewpoint. After entering this mode, the viewpoint of the virtual camera is switched when the user performs predetermined touch operation in the center of the screen. For example, when the user drags the screen with one finger, the virtual camera rotates. Furthermore, when the user drags the screen with two fingers, the virtual camera moves (pans) up, down, to the left, or to the right. When the user performs pinch-in or pinch-out with two fingers, the virtual camera moves in a far-near direction (zooms in or zooms out). When entering the viewpoint movement mode, the terminal device 20 functions as the viewpoint operation unit illustrated in FIG. 9.

The flight trajectory input mode button is a button for entering a mode for inputting a flight trajectory (a trajectory of the flight vehicle 30). After entering this mode, when the user performs predetermined touch operation (for example, slide operation) in the center of the screen, a flight trajectory (a trajectory of flight vehicle 30) can be drawn. After the drawing, the information processing device performs flight control of the flight vehicle 30 such that the flight vehicle 30 automatically flies along the trajectory.

The flight altitude display is display indicating a flyable area at altitude set by the user. In the example illustrated in FIG. 10, the information processing device superimposes and displays, on the virtual viewpoint image, a semitransparent movable plane indicating a flyable area at the current flight altitude of the flight vehicle 30.

The altitude indicator is display indicating the current flight altitude of the flight vehicle 30. In the case of FIG. 10, the current altitude of the flight vehicle 30 is 32 m. Note that the altitude indicator may be configured to be operable by the user such that altitude to be displayed in the flyable area can be changed. For example, in the example of FIG. 10, the altitude indicator may be configured such that the altitude to be displayed in the flyable area can be changed by the user touching a bar.

The hazard prediction alert is display for notifying the user which obstacle the flight vehicle 30 collides with at this altitude. In the example illustrated in FIG. 10, an alert is displayed on a mountain in the front of the flight vehicle 30.

The photographing preview is a real-time video photographed by the camera (the imaging unit 35) mounted on the flight vehicle 30. In the example illustrated in FIG. 10, in addition to the virtual viewpoint image, a captured image of the imaging unit 35 is displayed on the screen. Note that the image displayed on the screen may be switched from the virtual viewpoint image to the captured image based on operation of the user. For example, when the user touches the photographing preview illustrated in FIG. 10, the information processing device switches the entire screen of the terminal device 20 from the virtual viewpoint image to the captured image in the imaging unit 35.

### <3-3. Trajectory Planning>

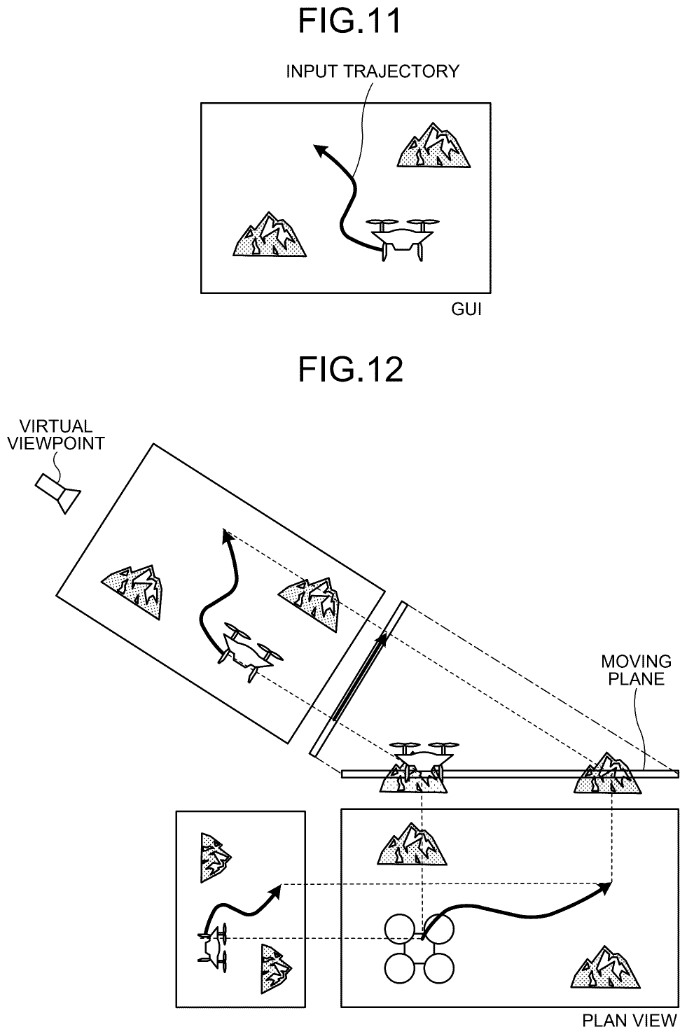

As explained above, the user can cause the flight vehicle 30 to automatically fly by inputting the trajectory (the flight trajectory) of the flight vehicle 30 to the virtual viewpoint image. FIG. 11 is a diagram illustrating a trajectory input to the virtual viewpoint image by the user. An arrow line illustrated in FIG. 11 is an input trajectory of the user. In the following explanation, determination of a trajectory of the flight vehicle 30 based on input to the virtual viewpoint image of the user is sometimes referred to as trajectory planning.

FIG. 12 is a diagram for explaining the trajectory planning. The information processing device performs the trajectory planning by projecting a trajectory (a 2D trajectory) input to the virtual viewpoint image by the user onto a moving plane of the flight vehicle 30. For example, the information processing device projects points included in the 2D orbit on the virtual viewpoint image onto the moving plane. For example, the information processing device sets, as a projection point, an intersection of a perpendicular line having a point included in the 2D orbit as a foot and the moving plane. The information processing device sets a point sequence projected onto the movement plane as a trajectory in a 3D space.

At this time, the information processing device may perform determination of collision with an obstacle. When any point collides, the information processing device may notify the user and reject the input trajectory.

### 4. Processing Example

The operation of the flight vehicle control system 1 is explained above. Various kinds of processing executed by the flight vehicle control system 1 are explained below with reference to a flowchart.

The processing of the flight vehicle control system 1 explained below may be executed by any one of the plurality of devices (the server 10, the terminal device 20, and the flight vehicle 30) configuring the flight vehicle control system 1 or may be executed by the control units (the information processing devices) of the plurality of devices configuring the flight vehicle control system 1 in cooperation. In the following explanation, it is assumed that the information processing device executes the processing.

An operation of the flight vehicle control system 1 is divided into map information acquisition processing, virtual viewpoint control processing, and virtual viewpoint image generation processing. After executing the map information acquisition processing, the information processing device executes the virtual viewpoint control processing and the virtual viewpoint image generation processing in parallel.

### <4-1. Map Information Acquisition Processing>

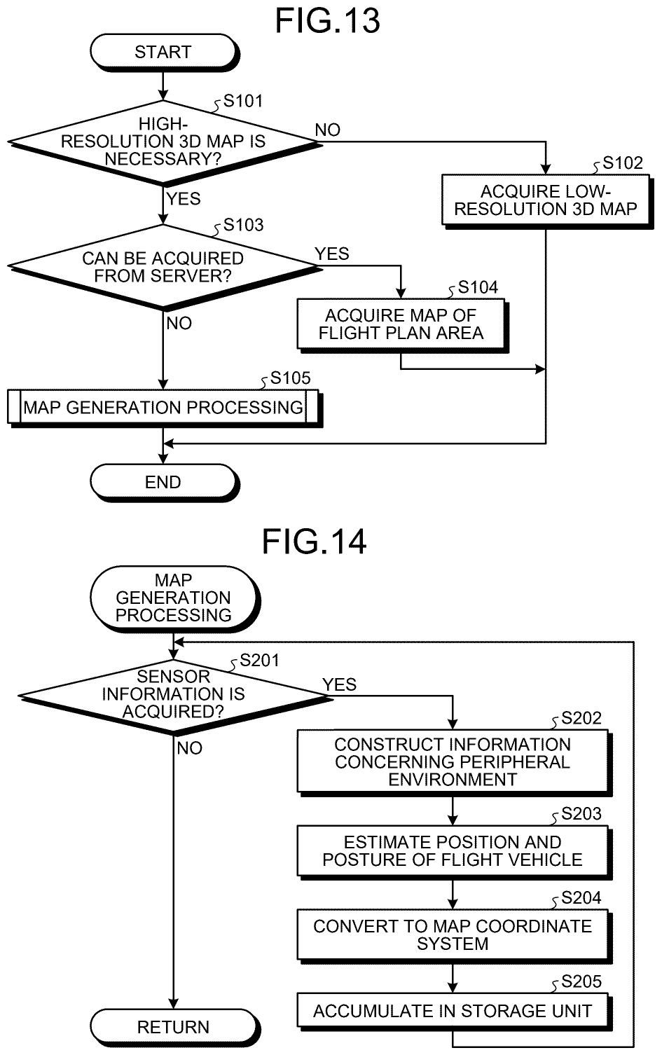

First, the map information acquisition processing is explained. The map information acquisition processing is processing for acquiring 3D map information for generating a virtual viewpoint image. FIG. 13 is a flowchart illustrating the map information acquisition processing. The information processing device starts the map information acquisition processing when the user performs operation for starting operation of the flight vehicle 30 (alternatively, input for flight preparation). The map information acquisition processing is explained below with reference to a flowchart of FIG. 13.

First, the information processing device discriminates whether high-resolution 3D map information is necessary for the current flight (Step S101). When the high-resolution 3D map information is unnecessary (Step S101: No), the information processing device acquires low-resolution 3D map information (Step S102).

At this time, the information processing device may acquire low-resolution 3D map information from the storage unit of the information processing device. For example, if the information processing device is the control unit 13 of the server 10, the information processing device may acquire low-resolution 3D map information from the storage unit 12. If the information processing device is the control unit 23 of the terminal device 20, the information processing device may acquire low-resolution 3D map information from the storage unit 22. If the information processing device is the control unit 33 of the flight vehicle 30, the information processing device may acquire low-resolution 3D map information from the storage unit 32. Note that the information processing device may acquire low-resolution 3D map information from another device via communication. For example, if the information processing device is the control unit 23 of the terminal device 20 or the control unit 33 of the flight vehicle 30, the information processing device may acquire low-resolution 3D map information from the server 10 via the network N.

When the high-resolution 3D map information is necessary (Step S101: Yes), the information processing device discriminates whether high-resolution 3D map information of a flight planning area can be acquired. For example, if the information processing device is the control unit 23 of the terminal device 20 or the control unit 33 of the flight vehicle 30, the information processing device discriminates whether high-resolution 3D map information can be acquired from the server 10 via the network N (Step S103). Note that the information processing device may discriminate whether high-resolution 3D map information can be acquired from the storage unit of the information processing device.

When high-resolution 3D map information can be acquired (Step S103: Yes), the information processing device acquires high-resolution 3D map information of the flight planning area from the server 10 or from the storage unit of the information processing device (Step S104).

When high-resolution 3D map information cannot be acquired (Step S103: Yes), the information processing device executes the map generation processing (Step S105). The map generation processing is processing for generating high-resolution 3D map information based on information from the sensor unit 34 of the flight vehicle 30. FIG. 14 is a flowchart illustrating map generation processing. The map generation processing is explained below with reference to the flowchart of FIG. 14.

The information processing device discriminates whether sensor information has been acquired from the sensor unit 34 of the flight vehicle 30 (Step S201). When sensor information has been acquired (Step S201: Yes), the information processing device constructs information concerning the peripheral environment of the flight vehicle 30 (Step S202). For example, the information processing device constructs, based on information from a depth sensor (for example, LiDAR) mounted on the flight vehicle 30, information concerning three-dimensional structure on the ground in an area where the flight vehicle 30 is currently flying.

Subsequently, the information processing device estimates a current position and a current posture of the flight vehicle 30 (Step S203). The information processing device converts, based on an estimation result in Step S203, information (for example, information concerning the three-dimensional structure on the ground) acquired in Step S202 into information of a map coordinate system (for example, the earth coordinate system) (Step S204). The information processing device accumulates a conversion result in the storage unit as 3D map information.

The information processing device repeats the processing in Step S201 to Step S205 until sensor information cannot be acquired. When sensor information cannot be acquired (Step S201: No), the information processing device ends the map generation processing.

Referring back to the flow of FIG. 13, when acquiring 3D map information in Step S102, Step S104, or Step S105, the information processing device ends the map information acquisition processing.

When the acquisition of 3D map information is completed, the information processing device executes the virtual viewpoint control processing and the virtual viewpoint image generation processing in parallel. The virtual viewpoint control processing and the virtual viewpoint image generation processing are repeatedly executed until the flight of the flight vehicle 30 ends.

### <4-2. Virtual Viewpoint Control Processing>

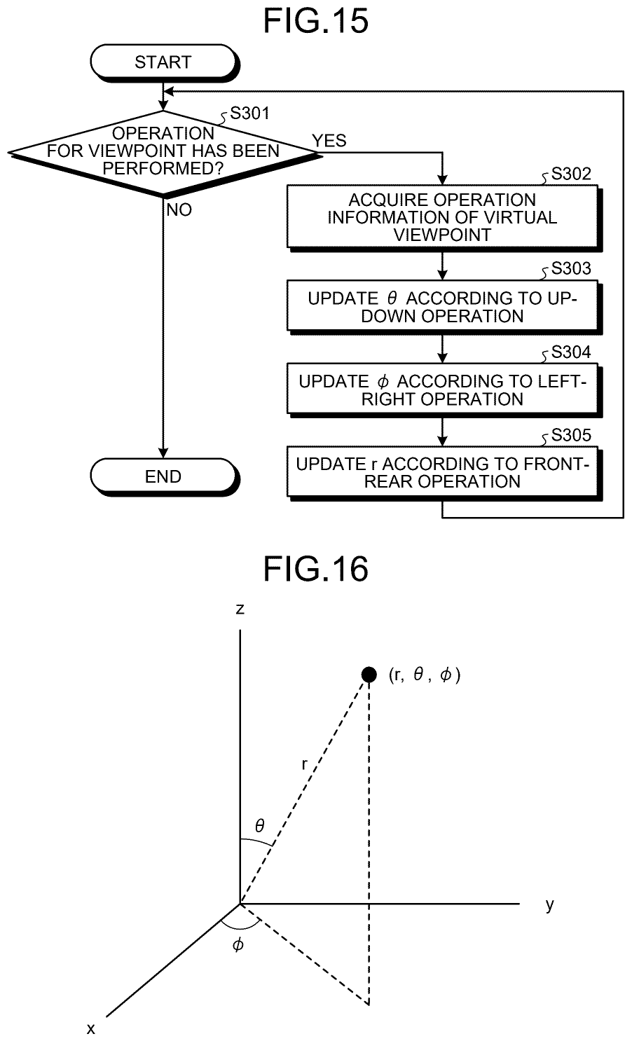

First, the virtual viewpoint control processing is explained. The virtual viewpoint control processing is processing for controlling the position of the virtual viewpoint according to operation of the user. FIG. 15 is a flowchart illustrating the virtual viewpoint control processing. The virtual viewpoint control processing is explained below with reference to the flowchart in FIG. 15.

First, the information processing device determines whether operation for the virtual viewpoint has been performed by the user (Step S301). When the operation has not been performed (Step S301: No), the information processing device ends the virtual viewpoint control processing.

When the operation has been performed (Step S301: Yes), the information processing device acquires operation information of the virtual viewpoint by the user (Step S302). The information processing device updates the position information of the virtual viewpoint based on the operation information.

Here, in the information processing device, the position information of the virtual viewpoint is relative position information based on the position of the flight vehicle 30. FIG. 16 is a diagram for explaining the position information of the virtual viewpoint. FIG. 16 illustrates a spherical coordinate system. The flight vehicle 30 is located in the center position (a position where an x axis, a y axis, and a z axis intersect) of the spherical coordinate system. The position of a black circle in the figure is the position of the virtual viewpoint. In the example illustrated in FIG. 16, the position of the virtual viewpoint is expressed by a distance r from the flight vehicle 30, an angle θ with the z axis (the up-down direction), and an angle ϕ with the x axis (the left-right direction). In the following explanation, the distance r, the angle θ, and the angle ϕ are used.

Referring back to the flow of FIG. 15, the information processing device updates the angle θ based on information concerning up-down operation of the user (Step S303). The information processing device updates the angle ϕ based on information concerning left-right operation of the user (Step S304). The information processing device updates the distance r based on information concerning front-rear operation of the user (Step S305).

When the update of the position information of the virtual viewpoint is completed, the information processing device returns the processing to Step S301.

### <4-3. Virtual Viewpoint Image Generation Processing>

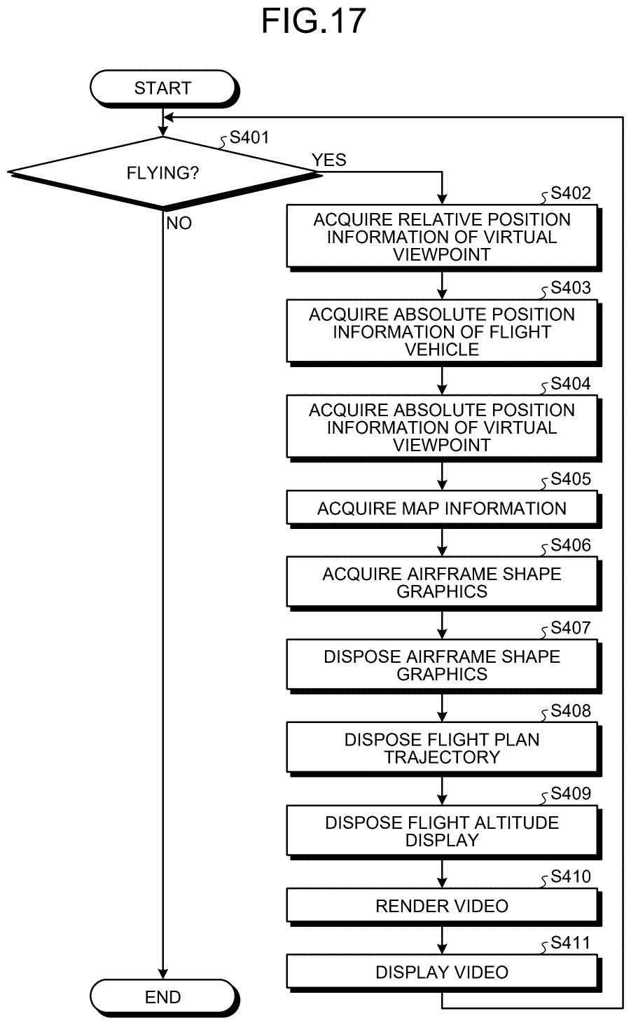

Next, the virtual viewpoint image generation processing is explained. The virtual viewpoint image generation processing is processing for generating a virtual viewpoint image to be displayed on the terminal device 20. FIG. 17 is a flowchart illustrating the virtual viewpoint image generation processing. The virtual viewpoint image generation processing is explained below with reference to the flowchart of FIG. 17.

First, the information processing device discriminates whether the flight vehicle 30 is flying (Step S401). When the flight vehicle 30 is not flying (Step S401: No), the information processing device ends the virtual viewpoint image generation processing.

When the flight vehicle 30 is flying (Step S401: Yes), the information processing device acquires the position information of the virtual viewpoint set by the user (Step S402). The position information acquired here is position information (relative position information) based on the position of the flight vehicle 30.

Subsequently, the information processing device acquires position information of the flight vehicle 30 (Step S403). For example, the information processing device acquires position information of the flight vehicle 30 based on sensor information (for example, GPS information) from the sensor unit 34. The position information acquired here is position information based on the map coordinate system (the earth coordinate system). In the following explanation, the position information based on the map coordinate system (the earth coordinate system) is referred to as absolute position information.

Subsequently, the information processing device acquires absolute position information of the virtual viewpoint (Step S404). For example, the information processing device calculates absolute position information of the virtual viewpoint based on the relative position information of the virtual viewpoint acquired in Step S402 and the absolute position information of the flight vehicle 30 acquired in Step S403.

Subsequently, the information processing device acquires 3D map information (Step S405). For example, the information processing device acquires the 3D map information acquired in the map information acquisition processing explained above. At this time, the information processing device may determine a necessary map area from the virtual viewpoint, the line-of-sight direction, and the viewing angle information and additionally acquire map information if there is an unacquired area. In the following explanation, a virtual 3D space configured by the 3D map information is simply referred to as 3D space.

Subsequently, the information processing device acquires airframe shape graphics (airframe 3D model information) of the flight vehicle 30 (Step S406). The information processing device disposes the airframe shape graphics of the flight vehicle 30 on the 3D space based on the absolute position information of the virtual viewpoint (Step S407). At this time, the information processing device may estimate a posture of the flight vehicle 30 based on, for example, information from the sensor unit 34 and rotate the airframe shape graphics in the 3D space to match the posture of the flight vehicle 30.

Subsequently, the information processing device specifies a flight plan trajectory of the flight vehicle 30 in the map coordinate system (the earth coordinate system) based on input of the user. Then, the information processing device disposes display of the flight plan trajectory of the flight vehicle 30 on the 3D space (Step S408).

Subsequently, the information processing device disposes display (for example, flight altitude display) indicating a flyable area on the 3D space (Step S409). For example, the information processing device specifies the current altitude of the flight vehicle 30 based on sensor information from the sensor unit 34. Then, the information processing device disposes a semitransparent plane in a position corresponding to the specified altitude in the 3D space.

Subsequently, the information processing device renders a video from the virtual viewpoint based on the information concerning the 3D space constructed in Steps S405 to S409 (Step S410). The information processing device displays the rendered video from the virtual viewpoint on the screen of the terminal device 20.

After displaying the video on the screen, the information processing device returns the processing to Step S401.

### 5. Modifications

The embodiment explained above indicates an example and various changes and applications of the embodiment are possible.

For example, in the virtual viewpoint control processing explained above, the information processing device controls the position of the virtual viewpoint according to the operation of the user. However, the information processing device may control not only the position of the virtual viewpoint but also the line-of-sight direction from the virtual viewpoint according to the operation of the user. Naturally, the information processing device may determine the line-of-sight direction from the virtual viewpoint based on the posture of the flight vehicle 30. For example, the information processing device may set the line-of-sight direction from the virtual viewpoint as a forward direction (that is, a traveling direction) of the flight vehicle 30.

The control device that controls the server 10, the terminal device 20, or the flight vehicle 30 of the present embodiment may be implemented by a dedicated computer system or may be implemented by a general-purpose computer system.

For example, a communication program for executing the operation explained above is distributed by being stored in a computer-readable recording medium such as an optical disk, a semiconductor memory, a magnetic tape, or a flexible disk. Then, for example, the program is installed in a computer and the control device is configured by executing the processing explained above. At this time, the control device may be a device (for example, a personal computer) on the outside of the server 10, the terminal device 20, or the flight vehicle 30. The control device may be a device (for example, the control unit 13, the control unit 23, or the control unit 33) on the inside of the server 10, the terminal device 20, or the flight vehicle 30.

The communication program explained above may be stored in a disk device included in a server device on a network such as the Internet such that the communication program can be downloaded to a computer. The functions explained above may be implemented by cooperation of an OS (Operating System) and application software. In this case, a portion other than the OS may be stored in a medium and distributed or a portion other than the OS may be stored in the server device and downloaded to the computer.

Among the processing explained in the embodiment, all or a part of the processing explained as being automatically performed can be manually performed or all or a part of the processing explained as being manually performed can be automatically performed by a known method. Besides, the processing procedure, the specific names, and the information including the various data and parameters explained in the document and illustrated in the drawings can be optionally changed except when specifically noted otherwise. For example, the various kinds of information illustrated in the figures are not limited to the illustrated information.

The illustrated components of the devices are functionally conceptual and are not always required to be physically configured as illustrated in the figures. That is, specific forms of distribution and integration of the devices are not limited to the illustrated forms and all or a part thereof can be functionally or physically distributed and integrated in any unit according to various loads, usage situations, and the like. Note that this configuration by the distribution and the integration may be dynamically performed.

The embodiments explained above can be combined as appropriate in a range for not causing the processing contents to contradict one another. Furthermore, the order of the steps illustrated in the flowchart of the embodiment explained above can be changed as appropriate.

For example, the present embodiment can be implemented as any component configuring a device or a system, for example, a processor functioning as a system LSI (Large Scale Integration) or the like, a module that uses a plurality of processors or the like, a unit that uses a plurality of modules or the like, or a set obtained by further adding other functions to the unit (that is, a component as a part of the device).

Note that, in the present embodiment, the system means a set of a plurality of components (devices, modules (parts), and the like) It does not matter whether all the components are present in the same housing. Therefore, both of a plurality of devices housed in separate housings and connected via a network and one device in which a plurality of modules are housed in one housing are systems.

For example, the present embodiment can adopt a configuration of cloud computing in which one function is shared and processed by a plurality of devices in cooperation via a network.

### 6. Conclusion

As explained above, according to the embodiment of the present disclosure, the information processing device generates the virtual viewpoint image based on the 3D map information, the current position information of the flight vehicle 30, and the information concerning the virtual viewpoint, the position of which can be changed by the user, and displays the generated image on the screen of the terminal device 20. Consequently, the user can operate the flight vehicle based on an image from any viewpoint (virtual viewpoint) in the 3D space rather than an image viewed from the flight vehicle 30 (for example, an image captured by the camera mounted on the flight vehicle 30). Therefore, the user can accurately operate the flight vehicle. Since the user can move the position of the virtual viewpoint and the line-of-sight direction from the virtual viewpoint, it is easy to grasp a positional relation between the flight vehicle and the periphery of the flight vehicle.

Although the embodiments of the present disclosure explained above, the technical scope of the present disclosure is not limited to the embodiments per se. Various changes can be made without departing from the gist of the present disclosure. Components in different embodiments and modifications may be combined as appropriate.

The effects in the embodiments described in this specification are only illustrations and are not limited. Other effects may be present.

Note that the present technique can also take the following configurations.

(1)

An information processing method executed by one processor or executed by a plurality of processors in cooperation, the information processing method comprising:
a first acquisition step for acquiring map information;
a second acquisition step for acquiring current position information of a flight vehicle;
a third acquisition step for acquiring information concerning a virtual viewpoint for a user to check the flight vehicle in an image; and
a generation step for generating a virtual viewpoint image, which is an image viewed from the virtual viewpoint, based on the map information, the current position information of the flight vehicle, and the information concerning the virtual viewpoint.
   (2)

The information processing method according to (1), wherein
the virtual viewpoint can be changed by operation of the user, and
in the third acquisition step, information concerning the virtual viewpoint specified based on input of the user is acquired.
   (3)

The information processing method according to (2), wherein
a line-of-sight direction from the virtual viewpoint can be changed by operation of the user, and
in the generation step, the virtual viewpoint image viewed from the virtual viewpoint in the line-of-sight direction is generated based on the map information, the current position information of the flight vehicle, the information concerning the virtual viewpoint, and the information concerning the line-of-sight direction specified based on the input of the user.
   (4)

The information processing method according to (2) or (3), comprising:
a fourth acquisition step for acquiring operation input of the user relating to flight control of the flight vehicle; and
a conversion step for converting the operation input of the user into control information for flight control of the flight vehicle, wherein
in the conversion step, a method of converting the operation input into the control information is changed according to a position of the virtual viewpoint.
   (5)

The information processing method according to any one of (1) to (4), wherein
the information concerning the virtual viewpoint is relative position information based on a position of the flight vehicle.
   (6)

The information processing method according to (5), wherein
the virtual viewpoint image is an image obliquely looking down the flight vehicle and a periphery of the flight vehicle from the virtual viewpoint.
   (7)

The information processing method according to (5), wherein
the virtual viewpoint is located above the flight vehicle, and
the virtual viewpoint image is an image looking down the flight vehicle and a periphery of the flight vehicle right below from the virtual viewpoint.
   (8)

The information processing method according to any one of (1) to (7), comprising
a display control step for displaying the virtual viewpoint image on a screen.
   (9)

The information processing method according to (8), wherein
a camera is mounted on the flight vehicle, and
in the display control step, a captured image captured by the camera mounted on the flight vehicle is displayed on the screen.
   (10)

The information processing method according to (9), wherein,
in the display control step, an image displayed on the screen is switched from the virtual viewpoint image to the captured image based on operation of the user.
   (11)

The information processing method according to (9), wherein,
in the display control step, the captured image is displayed on the screen in addition to the virtual viewpoint image.
   (12)

The information processing method according to any one of (8) to (11), wherein
in the first acquisition step, 3D map information is acquired as the map information, and
in the generation step, the virtual viewpoint image of 3D viewed from the virtual viewpoint is generated based on the 3D map information, the current position information of the flight vehicle, and the information concerning the virtual viewpoint.
   (13)

The information processing method according to (12), comprising
an estimation step for estimating a flyable area of the flight vehicle, wherein
in the generation step, display concerning the estimated flyable area is added to the virtual viewpoint image, and
in the display control step, the virtual viewpoint image to which the display concerning the flyable area is added is displayed on the screen.
   (14)

The information processing method according to (13), wherein
the 3D map information includes information concerning an object obstructing flight of the flight vehicle,
in the estimation step, a movable plane of the flight vehicle is estimated as the flyable area of the flight vehicle based on the 3D map information,
in the generation step, display of the movable plane of the flight vehicle is added to the virtual viewpoint image, and
in the display control step, the virtual viewpoint image to which the display of the movable plane of the flight vehicle is added is displayed on the screen.
   (15)

The information processing method according to any one of (12) to (14), comprising
a fifth acquisition step for acquiring input of the user concerning a flight trajectory of the flight vehicle, wherein
in the generation step, display of a flight plan trajectory of the flight vehicle specified based on the input of the user is added to the virtual viewpoint image, and
in the display control step, the virtual viewpoint image to which the display of the flight plan trajectory is added is displayed.
   (16)

The information processing method according to (15), comprising
a flight control step for controlling flight of the flight vehicle based on the flight plan trajectory of the flight vehicle.
   (17)

The information processing method according to any one of (1) to (16), wherein
the flight vehicle is a drone.
   (18)

An information processing program for causing one or a plurality of computers to function as:
a first acquisition unit that acquires map information;
a second acquisition unit that acquires current position information of a flight vehicle;
a third acquisition unit that acquires information concerning a virtual viewpoint for a user to check the flight vehicle in an image; and
a generation unit that generates a virtual viewpoint image, which is an image viewed from the virtual viewpoint, based on the map information, the current position information of the flight vehicle, and the information concerning the virtual viewpoint.
   (19)

An information processing device comprising:
a first acquisition unit that acquires map information;
a second acquisition unit that acquires current position information of a flight vehicle;
a third acquisition unit that acquires information concerning a virtual viewpoint for a user to check the flight vehicle in an image; and
a generation unit that generates a virtual viewpoint image, which is an image viewed from the virtual viewpoint, based on the map information, the current position information of the flight vehicle, and the information concerning the virtual viewpoint.

### REFERENCE SIGNS LIST

1 FLIGHT VEHICLE CONTROL SYSTEM
10 SERVER
20 TERMINAL DEVICE
30 FLIGHT VEHICLE
11, 21, 31 COMMUNICATION UNIT
12, 22, 32 STORAGE UNIT
13, 23, 33 CONTROL UNIT
24, 34 SENSOR UNIT
25 OPERATION UNIT
35 IMAGING UNIT
36 POWER UNIT
131, 231, 331 ACQUISITION UNIT
132, 232, 332 GENERATION UNIT
133, 233, 333 CONVERSION UNIT
134, 234, 334 DISPLAY CONTROL UNIT
135, 235, 335 ESTIMATION UNIT
136, 236, 336 FLIGHT CONTROL UNIT
N NETWORK

1. An information processing method executed by one processor or executed by a plurality of processors in cooperation, the information processing method comprising:
a first acquisition step for acquiring map information;
a second acquisition step for acquiring current position information of a flight vehicle;
a third acquisition step for acquiring information concerning a virtual viewpoint for a user to check the flight vehicle in an image; and
a generation step for generating a virtual viewpoint image, which is an image viewed from the virtual viewpoint, based on the map information, the current position information of the flight vehicle, and the information concerning the virtual viewpoint.

2. The information processing method according to claim 1, wherein
the virtual viewpoint can be changed by operation of the user, and
in the third acquisition step, information concerning the virtual viewpoint specified based on input of the user is acquired.

3. The information processing method according to claim 2, wherein
a line-of-sight direction from the virtual viewpoint can be changed by operation of the user, and
in the generation step, the virtual viewpoint image viewed from the virtual viewpoint in the line-of-sight direction is generated based on the map information, the current position information of the flight vehicle, the information concerning the virtual viewpoint, and the information concerning the line-of-sight direction specified based on the input of the user.

4. The information processing method according to claim 2, comprising:
a fourth acquisition step for acquiring operation input of the user relating to flight control of the flight vehicle; and
a conversion step for converting the operation input of the user into control information for flight control of the flight vehicle, wherein
in the conversion step, a method of converting the operation input into the control information is changed according to a position of the virtual viewpoint.

5. The information processing method according to claim 1, wherein
the information concerning the virtual viewpoint is relative position information based on a position of the flight vehicle.

6. The information processing method according to claim 5, wherein
the virtual viewpoint image is an image obliquely looking down the flight vehicle and a periphery of the flight vehicle from the virtual viewpoint.

7. The information processing method according to claim 5, wherein
the virtual viewpoint is located above the flight vehicle, and
the virtual viewpoint image is an image looking down the flight vehicle and a periphery of the flight vehicle right below from the virtual viewpoint.

8. The information processing method according to claim 1, comprising
a display control step for displaying the virtual viewpoint image on a screen.

9. The information processing method according to claim 8, wherein
a camera is mounted on the flight vehicle, and
in the display control step, a captured image captured by the camera mounted on the flight vehicle is displayed on the screen.

10. The information processing method according to claim 9, wherein,
in the display control step, an image displayed on the screen is switched from the virtual viewpoint image to the captured image based on operation of the user.

11. The information processing method according to claim 9, wherein,
in the display control step, the captured image is displayed on the screen in addition to the virtual viewpoint image.

12. The information processing method according to claim 8, wherein
in the first acquisition step, 3D map information is acquired as the map information, and
in the generation step, the virtual viewpoint image of 3D viewed from the virtual viewpoint is generated based on the 3D map information, the current position information of the flight vehicle, and the information concerning the virtual viewpoint.

13. The information processing method according to claim 12, comprising
an estimation step for estimating a flyable area of the flight vehicle, wherein
in the generation step, display concerning the estimated flyable area is added to the virtual viewpoint image, and
in the display control step, the virtual viewpoint image to which the display concerning the flyable area is added is displayed on the screen.

14. The information processing method according to claim 13, wherein
the 3D map information includes information concerning an object obstructing flight of the flight vehicle,
in the estimation step, a movable plane of the flight vehicle is estimated as the flyable area of the flight vehicle based on the 3D map information,
in the generation step, display of the movable plane of the flight vehicle is added to the virtual viewpoint image, and
in the display control step, the virtual viewpoint image to which the display of the movable plane of the flight vehicle is added is displayed on the screen.

15. The information processing method according to claim 12, comprising
a fifth acquisition step for acquiring input of the user concerning a flight trajectory of the flight vehicle, wherein
in the generation step, display of a flight plan trajectory of the flight vehicle specified based on the input of the user is added to the virtual viewpoint image, and
in the display control step, the virtual viewpoint image to which the display of the flight plan trajectory is added is displayed.

16. The information processing method according to claim 15, comprising
a flight control step for controlling flight of the flight vehicle based on the flight plan trajectory of the flight vehicle.

17. The information processing method according to claim 1, wherein
the flight vehicle is a drone.

18. An information processing program for causing one or a plurality of computers to function as:
a first acquisition unit that acquires map information;
a second acquisition unit that acquires current position information of a flight vehicle;
a third acquisition unit that acquires information concerning a virtual viewpoint for a user to check the flight vehicle in an image; and
a generation unit that generates a virtual viewpoint image, which is an image viewed from the virtual viewpoint, based on the map information, the current position information of the flight vehicle, and the information concerning the virtual viewpoint.

19. An information processing device comprising:
a first acquisition unit that acquires map information;
a second acquisition unit that acquires current position information of a flight vehicle;
a third acquisition unit that acquires information concerning a virtual viewpoint for a user to check the flight vehicle in an image; and
a generation unit that generates a virtual viewpoint image, which is an image viewed from the virtual viewpoint, based on the map information, the current position information of the flight vehicle, and the information concerning the virtual viewpoint.
